(19) United States
(12) Patent Application Publication
(10) Pub. No.: US 2003/0112641 A1
(43) Pub. Date: Jun. 19, 2003

(54) Photocoupler semiconductor device

(76) Inventor: Akira Kaneko, Tokyo (JP)

Correspondence Address: KANESAKA & TAKEUCHI, 1423 Powhatan Street, Alexandria, VA, 22314, US

(21) Appl. No.: 10/244,027

(22) Filed: Sep. 16, 2002

(30) Foreign Application Priority Data
Dec. 18, 2001 (JP) 2001-385325

(51) Int. Cl. H02M 3/335

(52) U.S. Cl. 363/21.07

(57) ABSTRACT

A photocoupler semiconductor device comprises a light receiving device (12) for generating electric current; a control circuit (16); and a constant current circuit (14) having a resistor (20′) for detecting the generated current to provide the control circuit (16) with a current command. The resistor (20′) allows the electric current to increase with the amount of current received.

### BACKGROUND OF THE INVENTION

1. Field of the Invention

The present invention relates to discharge control circuits for a metal-oxide-semiconductor field effect transistor (MOSFET) output photocoupler (hereinafter “photocoupler semiconductor device”).

2. Description of the Related Art

FIG. 7 shows the electrical circuit of a conventional photocoupler semiconductor device. A control circuit 16 comprises a p-n-p transistor 26, a diode 28, an n-p-n transistor 30, and a photodiode 24. The emitter electrode of the p-n-p transistor 26 is connected to the gate electrodes of MOSFETs 18-1 and 18-2, the collector of the n-p-n transistor 30 is connected to the base of the p-n-p transistor 26, and the cathode of the photodiode 24 is connected to both the collector of the p-n-p transistor 26 and the base of the n-p-n transistor 30. The cathode of the diode 28 is connected to the emitter of the p-n-p transistor 26 and its anode to both the anode of the light receiving device 12 (a series connection of light receiving elements) and the base of the p-n-p transistor 26. The collector of the n-p-n transistor 30 is connected to the base of the n-p-n transistor 26 and the its emitter to both the anode of the photodiode 24 and the sources of the MOSFETs 18-1 and 18-2.

How to drive the photocoupler semiconductor device will be described.

The MOSFETs 18-1 and 18-2 are turned on as follows. The input current If to the light emitting element 10 produces light. The light receiving device 12 receives the light and supplies power produced across the anode and cathode to the gates of the MOSFETs 18-1 and 18-2, turning on the gate-source regions of the MOSFETs 18-1 and 18-2 and conducting electric current.

The photocoupler semiconductor device is turned off as follows. When the input current, If, to the light emitting element 10 is turned off, the light receiving device 12 no longer produces power. The MOSFETs 18-1 and 18-2, however, are not turned off immediately because of the accumulated charges therein. Consequently, the potential at the gate of the MOSFETs 18-1 and 18-2 is higher than the potential at the anode of the light receiving device 12 so that electric current flows from the gates of the MOSFETs 18-1 and 18-2 to the anode of the light receiving device 12. At this point, the diode 28 of the control circuit 16 is inversely biased so that the current does not flow to the diode 28 but the emitter of the p-n-p transistor 26, turning on the p-n-p transistor 26. Since the photodiode 24 is inversely biased, the current flows from the collector of the p-n-p transistor 26 to the base of the n-p-n transistor 30, turning on the n-p-n transistor 30. Consequently, the current flows from the gate of the MOSFET 18 through the emitter of the n-p-n transistor 30. As a result, the connection points E and F are short-circuited to discharge electric charges of the MOSFETs 18-1 and 18-2, which turns off the photocoupler semiconductor device.

The turn-on time of the photocoupler semiconductor device of FIG. 7 is determined by the time period in which the light current from the light receiving device 12 accumulates electric charges in the gate capacity of MOSFET. Accordingly, as shown in FIG. 8, the turn-on time varies with the input current to the light emitting element 10. FIG. 8 shows the input current vs. turn-on time characteristic for the conventional photocoupler semiconductor device, wherein the relationship shows a substantially hyperbolic curve.

In order to provide a slow-on control having a long turn-on time, it has been necessary to control the magnitude of an input current precisely. To solve such a problem, it has been proposed that a constant current circuit, such as shown in FIG. 9, is added across the output terminals 2 and 2′ of the light receiving device 12 to control the dependency of the turn-on time. FIG. 9 shows the circuit diagram of a photocoupler semiconductor device equipped with a conventional constant current control. This constant current circuit 14 comprises a resistor 20 and an n-p-n transistor 22. One end of the resistor 20 and the emitter electrode of the n-p-n transistor 22 are connected to the connection point 2′. The other end of the resistor 20 is connected to the base electrode of the n-p-n transistor 22. The collector of the n-p-n transistor 22 is connected to the output terminal 2.

In such a structure, the electric current from the photodiode produces a voltage drop across the resistor 20. If the voltage drop, which is a potential difference between the emitter and the base of the n-p-n transistor 22, exceeds the threshold (0.6 V for example), the n-p-n transistor 22 is turned on, discharging the electric charges from the MOSFETs 18. At this point, the voltage drop by the transistor 22 is below 0.6 V, turning off the transistor 22.

The off condition of the transistor 22 supplies electric charges to the MOSFETs 18, producing the voltage drop, resulting in the on-condition again. Such a sequential operation repeats to make the electric current constant in the constant current circuit. The value of electric current is determined by the resistor 20 and the threshold between the base and the emitter of the n-p-n transistor 22. For example, the electric current is 1 μA for a threshold of 0.6 V and a resistance of 0.6 MΩ.

At this point, a loop path is formed to couple the anode of the light receiving device 12, the gates and the sources of MOSFETs 18-1 and 18-2, and the cathode of the light receiving device 12. When the current value exceeds a set value of 1 μA, the constant current circuit starts to operate, turning on the MOSFETs 18-1 and 18-2. Accordingly, it is possible to make the on-time, Ton, of the photocoupler semiconductor device circuit and the response time of the rise time, Tr, substantially constant despite variations of the input current, If, to the light emitting element 3.

Since the constant current circuit 14 keeps the light current constant, the accumulation time in the gate capacity of MOSFETs 18-1 and 18-2 is made constant, which in turn makes the turn-on time constant. The dependency on the input current, If, of the photocoupler semiconductor device with the constant current circuit 14 is shown in FIG. 10, wherein the turn-on time remains substantially constant with respect to the input current.

The above photocoupler semiconductor device with the constant current circuit, however, cannot be used for controlling the turn-on time under a plurality of conditions. For example, to provide a slow-on and fast-on operation in the Office Channel Unit (OCU) switch of Integrated Services Digital Network (ISDN), it cannot be used in such a case that the required turn-on time is 10 ms for a certain timing and 1 ms for another timing.

### SUMMARY OF THE INVENTION

Accordingly, it is an object of the invention to provide a photocoupler semiconductor device with a constant current circuit enabling to change the turn-on time without difficulty.

### BRIEF DESCRIPTION OF THE DRAWINGS

FIG. 1 is a circuit diagram of a photocoupler semiconductor device according to the first embodiment of the invention;

FIG. 2 is a plan view of a circuit pattern according to the first embodiment;

FIG. 3 is a graph showing the input current vs. turn-on time characteristic of the photocoupler semiconductor device;

FIG. 4 is a plan view of a circuit pattern according to the second embodiment of the invention;

FIG. 5 is a graph showing the input current vs. turn-on time characteristic according to the second embodiment;

FIG. 6(a) is a plan view of a semiconductor resistor element constituting a resistor according to the invention;

FIG. 6(b) is the semiconductor resistor element with a light shielding film;

FIG. 6(c) is a sectional view taken along line A-A′ of FIG. 6(b);

FIG. 7 is a circuit diagram of a conventional photocoupler semiconductor device;

FIG. 8 is a graph showing the input current vs. turn-on time characteristic of the conventional photocoupler semiconductor device;

FIG. 9 is a circuit diagram of a conventional photocoupler semiconductor device with a constant current control; and

10 is a graph showing the input current vs. turn-on time characteristic of the conventional photocoupler semiconductor device.

### DESCRIPTION OF THE PREFERRED EMBODIMENTS

Embodiments of the invention will now be described with reference to the accompanying drawings.

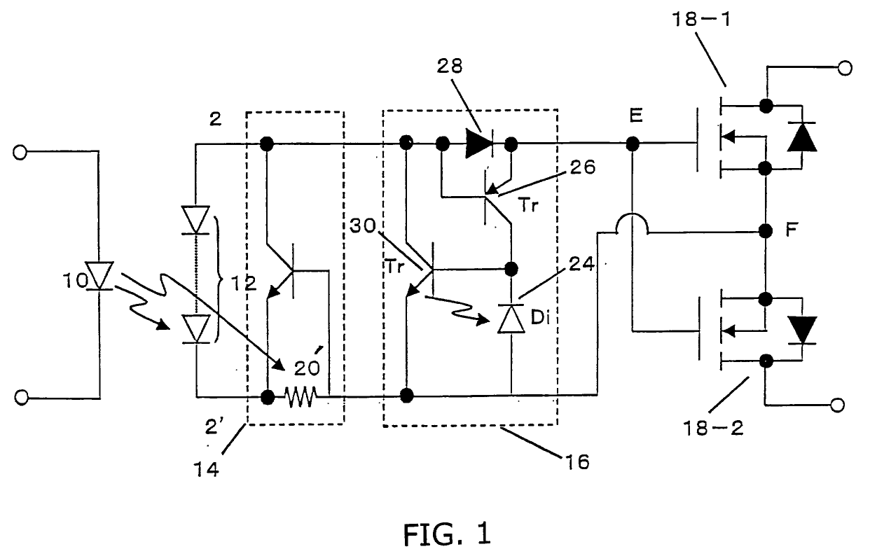

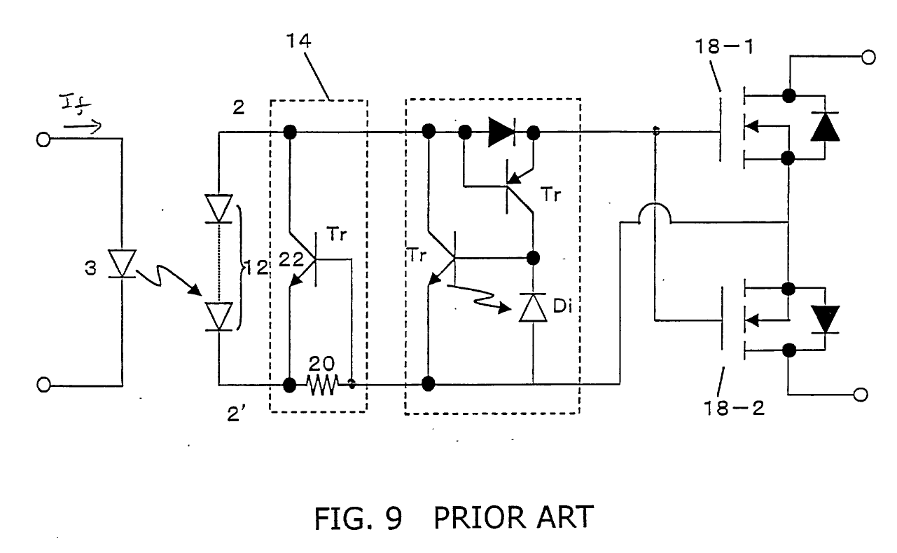

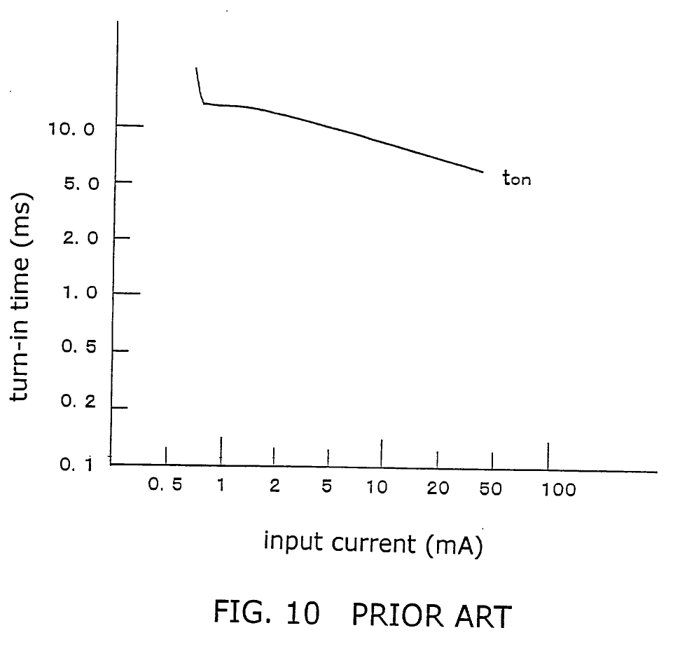

In FIG. 1, the constant current circuit according to the first embodiment comprises a light receiving or photovoltaic device 12, a constant current circuit 14, and a control circuit 16. The resistor 20′ of the constant current circuit, however, is different from the conventional one in FIG. 9 as follows. That is, it has a resistance characteristic that the current value increases with the light amount received.

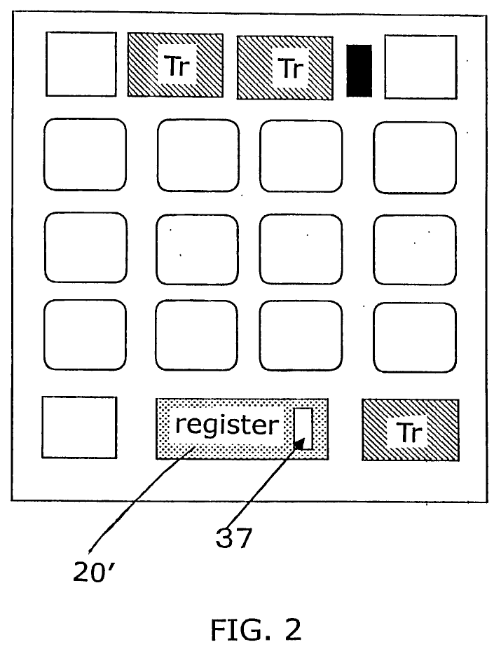

In FIG. 2, the resistor 20′ has an opening 37 in the light shielding film for receiving light that strikes the photovoltaic device 12, too. Transistor circuits and photodiodes are represented by Tr and rounded squares, respectively.

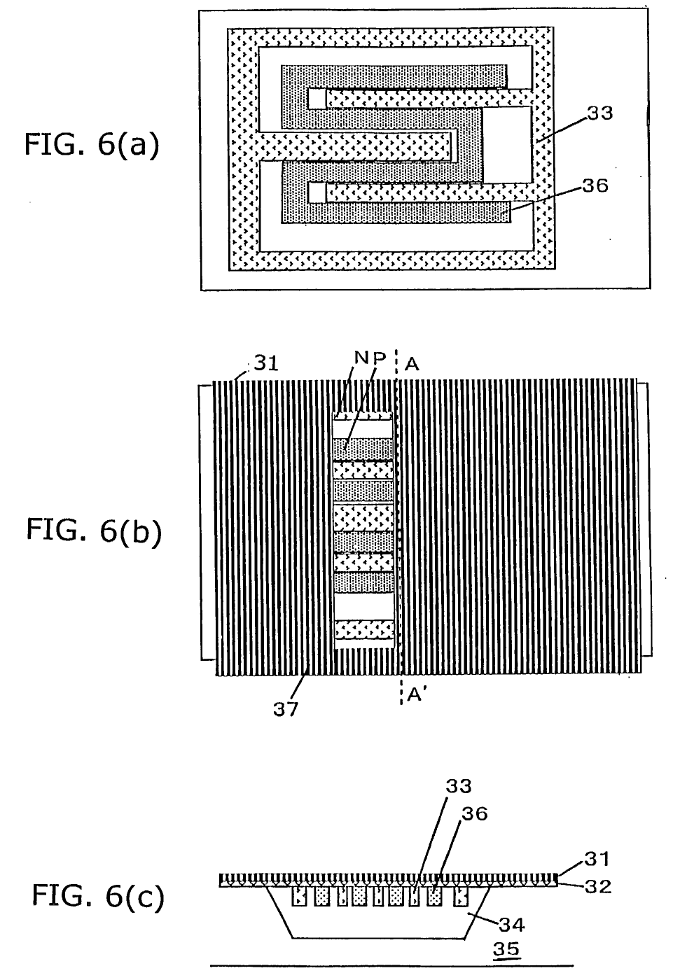

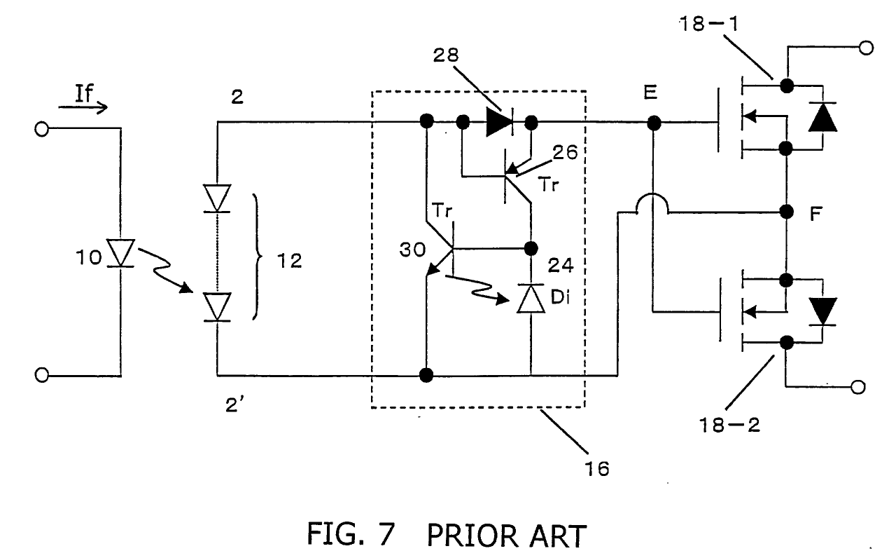

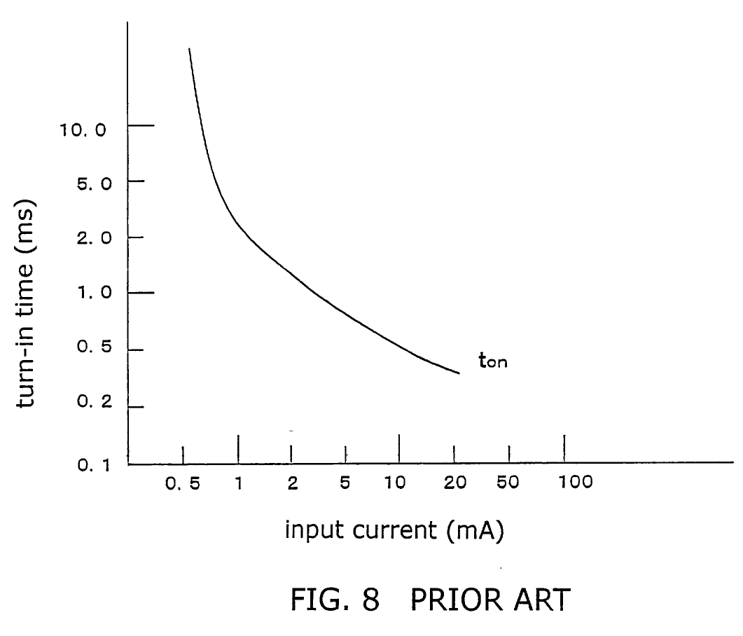

The resistor 20′, which has such a pattern as shown in FIG. 2, is made by a process such as shown in FIGS. 6(a) through (c).

The semiconductor resistor element is provided on one of the n-type monolithic islands 34 formed on a dielectric partition board 35. A p-type semiconductor layer 36 and an n-type semiconductor layer 33 having a density higher than that of the board are formed by diffusion process on the monolithic island 34, respectively. Then, an insulation film 32 is coated and a light shielding film 31 is formed thereon with aluminum. The p-type semiconductor 36 constitutes the resistor 20′. The n-type semiconductor layer 33 is provided to not only prevent current leak through the surface of the n-type monolithic island 34 but also conduct current to the p-type semiconductor layer 36.

In this resistor 20′, the n-p-n junction can form a parasitic phototransistor. To prevent it, the light shielding film 31 is provided over the entire surface of the resistor 20′ to prevent incident light to the p-n-p junction. The p-type semiconductor layer 36 is formed in a zigzag fashion to increase the distance between the terminals and thus the resistance. According to the invention, the opening 37 is provided in the light shielding film 31 and the insulation film 32 to expose the p-type semiconductor layer 36 so that it can receive light. When light strikes the opening 37, the junction between the p-type semiconductor layer 36 and the n-type monolithic island 34 operates as a parasitic phototransistor. This diffusion resistance allows the current flow to increase with the amount of light received in the normal range of usage.

The operation of MOSFETs 18-1 and 18-2 that are connected to the semiconductor resistor element will be described below.

In FIG. 1, when light strikes the light receiving device 12, each light receiving diode 12 produces an electromotive force of approximately 0.6 V so that a voltage of about 5 V is established across the terminals 2 and 2′. The electric charges produced by this voltage are accumulated in the gates of the driven transistors MOSFETs 18-1 and 18-2 to turn them on. When the p-type semiconductor layer 36 receives the light, it works as not only a resistor but also a parasitic phototransistor in cooperation with the n-type semiconductors 33 and 34.

When there is no light illumination, there is no electromotive force so that the electric charges stored in the gates of MOSFETs 18-1 and 18-2 are discharged through the p-type semiconductor layer 36 to turn them off.

By providing the opening 37 in the light shielding film 31 it is possible to form a parasitic phototransistor in the region of the opening 37 so that the number of parasitic phototransistors is increased so as to change the resistance characteristic.

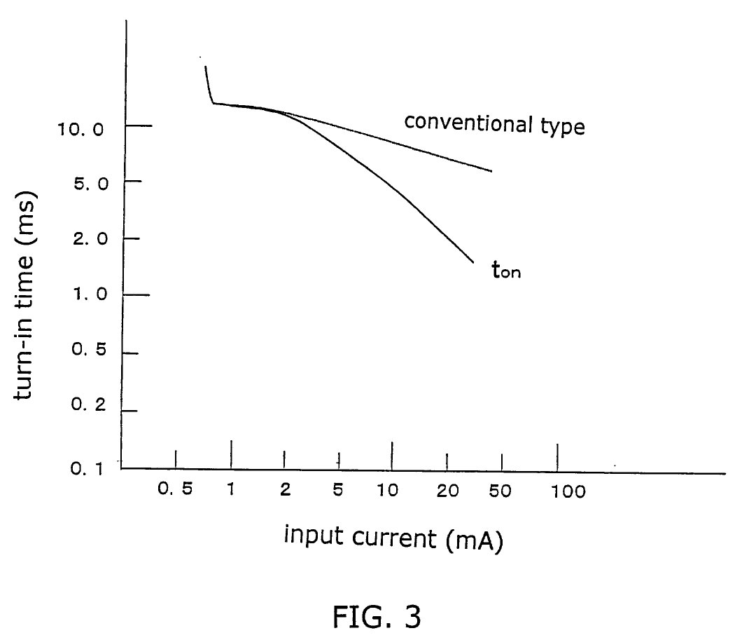

The input current vs. turn-on time characteristic of the photocoupler semiconductor device according to the invention is shown in FIG. 3. When the input current increases, the turn-on time decreases more than the conventional device that is represented by dotted line. In other words, the turn-on time can be selected in a range wider than that of the conventional one with respect to the input current.

In operation, when electric current flows through the light emitting element 10, such as a light emitting diode, the light emitting element 10 gives off light and the light receiving device 12, such as photodiodes, generates an electromotive force to apply a voltage to the gates of MOSFETs 18-1 and 18-2 to turn them on. The light from the light emitting element 10 strikes the resistor 20′, too. When the light is weak, the resistance value of the resistor 20′ is little changed but as the light increases, the parasitic phototransistor operates to reduce the resistance value.

The constant current of the constant current circuit 14 is determined by this resistor value so that the larger the received light amount, the higher the electric current. Consequently, at a time of small light amounts, the resistance is high to provide a low level of current, thus lengthening the turn-on time. As the received light amount increases, the current value increases to shorten the turn-on time. The turn-on time dependency on the input power is shown in FIG. 3 in comparison with the conventional one.

As shown in FIG. 3, the turn-on time varies widely with the input current so that it is possible to control the turn-on time to be approximately 10 ms at approximately 1 mA of the LED current and below 2 ms at 10 mA or more of the LED current regardless of the LED power.

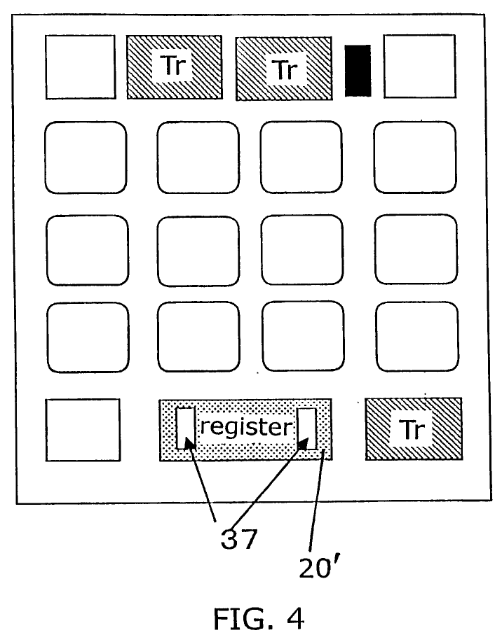

According to the second embodiment, two or more openings are provided so as to increase the LED current dependency or the received light amount. The circuit pattern according to the second embodiment is shown in FIG. 4, wherein two openings 37 are provided in the light shielding film 31 that covers the p-type semiconductor layer 36. Alternatively, three or more openings 37 may be provided.

In operation, electric current makes the LED 10 emit light, the photodiodes 12 generate the output corresponding to the received light amount and the resistor 20′ has the resistant value corresponding to the light amount to the LED 10. As described above, the constant current circuit 14 with the resistor 20′ supplies a constant current to MOSFETs 18-1 and 18-2 to turn them on. Since there are two openings 37 in the light shielding film 31, such parasitic phototransistor effects as described above are produced at two places to quickly shorten the turn-on time with the increased light amount received.

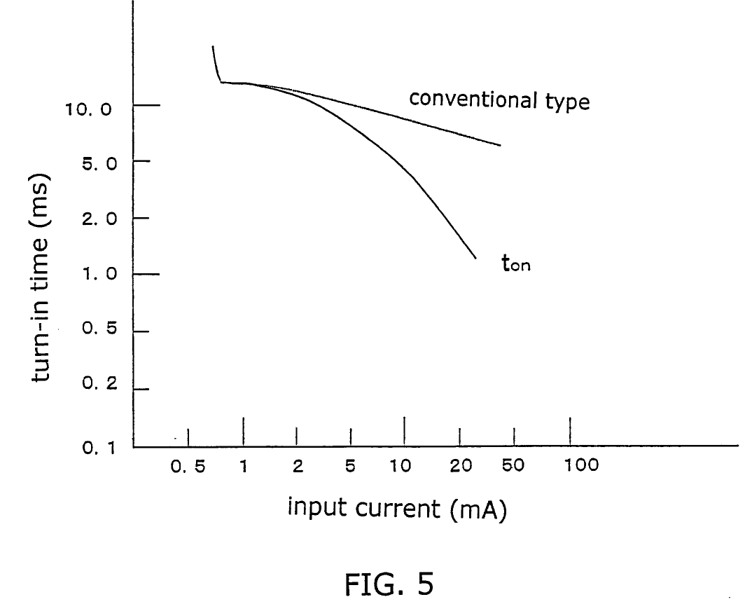

The input current vs. turn-on time characteristic of the second embodiment is shown in FIG. 5. As the input current increases, the turn-on time decreases to a large extent. The turn-on time is approx. 10 ms at 1 mA of the LED current and 1 ms or lower at 10 mA or more of the LED current.

Alternatively, the opening 37 may take any shape as well as square. The constant current circuit 14 may be any circuit capable of providing a constant current by means of the resistor that its resistant value increases with the received light amount.

As has been described above, according to the invention, it is possible to shorten the turn-on time of a photocoupler semiconductor device to a large extent as the input current increases. Thus, it is possible to provide the characteristic that the turn-on time varies widely with the input current.

1. A photocoupler semiconductor device comprising:
a light receiving device;
a control circuit connected to said light receiving device; and
a constant current circuit connected between said light receiving device and said control circuit and having a resistor with its resistance decreasing as an amount of light received increases.

2. The photocoupler semiconductor device according to claim 1, wherein said resistor is covered with a light shielding film with at least one opening such that as said mount of light increases, a turn-on time of said control circuit decreases.

3. The photocoupler semiconductor device according to claim 2, wherein the number of said openings is two.

4. The photocoupler semiconductor device according to claim 1, wherein said resistor has a diffusion region.

5. The photocoupler semiconductor device according to claim 4, wherein said diffusion region has a zigzag shape.

6. The photocoupler semiconductor device according to claim 4, wherein said diffusion region embedded in another region that has a conduction type different from that of said diffusion region.
